(19) United States
(12) Patent Application Publication
(10) Pub. No.: US 2017/0040794 A1
(43) Pub. Date: Feb. 9, 2017

(54) POWER SUPPLY DEVICE AND SYSTEM AND METHOD FOR PROVIDING POWER

(71) Applicants: Yi-Chun Lu, New Taipei City (TW); Po-Wen Cheng, New Taipei City (TW); Ya-Cherng Chu, New Taipei City (TW)

(72) Inventors: Yi-Chun Lu, New Taipei City (TW); Po-Wen Cheng, New Taipei City (TW); Ya-Cherng Chu, New Taipei City (TW)

(73) Assignee: OPTOMA CORPORATION, New Taipei City (TW)

(21) Appl. No.: 14/816,080

(22) Filed: Aug. 3, 2015

(51) Int. Cl. H02J 1/00

(52) U.S. Cl. CPC H02J 1/00

(57) ABSTRACT

A power supply device adapted to being coupled to an electronic apparatus through an input interface is provided. The power supply device includes a first-polarity voltage line, a second-polarity voltage line, and an output interface. The first-polarity voltage line and the second-polarity voltage line are disconnected with each other. The output interface is configured to supply a power to the electronic apparatus through the input interface. When the output interface is externally approached or forced by the input interface, the output interface chooses one of the first-polarity voltage line and the second-polarity voltage line as a chosen voltage line for the power. Multiple power supply devices may be arranged to be a power supply system.

### BACKGROUND OF THE INVENTION

1. Field of the Invention

The invention generally relates to technology for supplying power. Particularly, the invention relates to power supply device with capability to automatically choose a voltage line with electrical polarity.

2. Description of Related Art

When a DC power source is to supply the DC power, it needs to specifically indicate the electrical polarity for the connection terminals. However, even doing so, the user of the electronic mobile apparatus still needs to pay attention about the connection with proper polarity. Thus causes inconvenient to the user to use the DC power source as provided in the public area. However, an intelligent connection interface needs to be developed.

The information disclosed in this “BACKGROUND OF THE INVENTION” section is only for enhancement of understanding of the background of the invention and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention were acknowledged by a person of ordinary skill in the art.

### SUMMARY OF THE INVENTION

One object of the present invention is to provide a power supply device with capability to automatically choose a voltage line with electrical polarity. The power supply device may be further used to form a power supply system.

Other objects and advantages of the invention can be further illustrated by the technical features broadly embodied and described as follows.

In order to achieve one or a portion of or all of the objects or other objects, an embodiment of the invention provides a power supply system. As an aspect in the invention, in an embodiment, a power supply system is provided. The power supply system includes an input interface and a power supply apparatus. The input interface is adapted to being coupled to an electronic apparatus. The power supply apparatus includes a polarity-to-be-determined area and a plurality of power supply devices distributed in the polarity-to-be-determined area. The electronic apparatus is coupled to the power supply apparatus through the power supply devices and the input interface to obtain a power. Each of the power supply devices includes a first-polarity voltage line, a second-polarity voltage line, and an output interface. The first-polarity voltage lines are disconnected with the second-polarity voltage lines. The output interface is approached or forced by the input interface to accordingly choose at least one of the first-polarity voltage lines and at least one of the second-polarity voltage lines as a voltage output for the power. The at least one of the first-polarity voltage lines is referred as at least one chosen first-polarity voltage line and the at least one of the second-polarity voltage lines is referred as at least one chosen second-polarity voltage line. The at least one chosen first-polarity voltage line and the at least one chosen second-polarity voltage line belong to different power supply devices.

As another aspect of the invention, in another embodiment, a power supply device adapted to being coupled to an electronic apparatus through an input interface is provided. The power supply device includes a first-polarity voltage line, a second-polarity voltage line, and an output interface. The first-polarity voltage line and the second-polarity voltage line are disconnected with each other. The output interface is configured to supply a power to the electronic apparatus through the input interface. When the output interface is externally approached or forced by the input interface, the output interface chooses one of the first-polarity voltage line and the second-polarity voltage line as a chosen voltage line for the power.

As another aspect of the invention, in an embodiment, a method for providing power to an electronic apparatus is provided. The method includes: providing an input interface, wherein the input interface is adapted to being coupled to the electronic apparatus; providing a power supply apparatus, wherein the power supply apparatus includes a polarity-to-be-determined area and a plurality of power supply devices distributed in the polarity-to-be-determined area, wherein the electronic apparatus is coupled to the power supply apparatus through the power supply devices and the input interface to obtain a power, wherein each of the power supply devices comprises a first-polarity voltage line, a second-polarity voltage line, and an output interface, wherein the first-polarity voltage lines are disconnected with the second-polarity voltage lines; and choosing at least one of the first-polarity voltage lines and at least one of the second-polarity voltage lines as a voltage output for the power by using the input interface to approach or force the output interface, wherein the at least one of the first-polarity voltage lines is referred as at least one chosen first-polarity voltage line, the at least one of the second-polarity voltage lines is referred as at least one chosen second-polarity voltage line, the at least one chosen first-polarity voltage line and the at least one chosen second-polarity voltage line belong to different power supply devices.

As another aspect of the invention, in an embodiment, the electronic apparatus is adapted to be coupled to the power supply apparatus through the power supply devices and the input interface to obtain a power. Each of the power supply devices includes a first-polarity voltage line, a second-polarity voltage line, and an output interface. The first-polarity voltage lines are disconnected with the second-polarity voltage lines. The at least one of the first-polarity voltage lines is referred as at least one chosen first-polarity voltage line and the at least one of the second-polarity voltage lines is referred as at least one chosen second-polarity voltage line. The at least one chosen first-polarity voltage line and the at least one chosen second-polarity voltage line belong to different power supply devices.

As another aspect of the invention, in an embodiment, a method for providing power of a power supply device is provided. The power supply device is adapted to being coupled to an electronic apparatus through an input interface. The method includes: providing the power supply device having an output interface, a first-polarity voltage line, and a second-polarity voltage line; supplying a power to the electronic apparatus through the input interface and the output interface; and choosing one of the first-polarity voltage line and the second-polarity voltage line as a chosen voltage line for the power by using the input interface to externally approach or force the output interface. The first-polarity voltage line and the second-polarity voltage line are disconnected with each other.

In a further embodiment of the power supply system and the method for providing power to an electronic apparatus of the invention above, when the output interfaces of the plurality of the power supply devices are approached by the input interface, the at least one chosen first-polarity voltage line and the at least one chosen second-polarity voltage line are configured to extend to respectively connect with the corresponding output interfaces, and the other first-polarity voltage lines and the other second-polarity voltage lines are in disconnection with the output interfaces.

In a further embodiment of the power supply system and the method for providing power to an electronic apparatus of the invention, each of the first-polarity voltage lines and the second-polarity voltage lines is extensible and magnetic, when the output interfaces are approached by the input interface. The at least one chosen first-polarity voltage line is configured to extend to connect with the at least one corresponding output interface through a first magnetic force between the at least one chosen first-polarity voltage line and the corresponding output interface. The at least one chosen second-polarity voltage line is configured to extend to connect with the at least one corresponding output interface through a second magnetic force between the at least one chosen second-polarity voltage line and the corresponding output interface.

In a further embodiment of the power supply system and the method for providing power to an electronic apparatus of the invention, each of the output interfaces includes a conductive member. The conductive member is configured to be in connection between the corresponding output interface and the corresponding chosen first-polarity voltage line or between the corresponding output interface and the corresponding chosen second-polarity voltage line. When the output interfaces are approached or forced by the input interface, the at least one chosen first-polarity voltage line is configured to be connected with the corresponding conductive member so as to further connect with the corresponding output interface, the at least one chosen second-polarity voltage line is configured to be connected with the corresponding conductive member so as to further connect with the corresponding output interface, and the other first-polarity voltage lines and the other second-polarity voltage lines are in disconnection with the output interfaces.

In a further embodiment of the power supply system and the method for providing power to an electronic apparatus of the invention, the conductive members are magnetic switches. When the output interfaces are approached by the input interface, the at least one chosen first-polarity voltage line is configured to be connected with the corresponding conductive member to further connect with the at least one corresponding output interface through a first magnetic force between the at least one chosen first-polarity voltage line and the corresponding output interface, and the at least one chosen second-polarity voltage line is configured to be connected with the corresponding conductive member to further connect with the at least one corresponding output interface through a second magnetic force between the at least one chosen second-polarity voltage line and the corresponding output interface.

In a further embodiment of the power supply system and the method for providing power to an electronic apparatus of the invention, the output interfaces are movable. When the output interfaces are forced by the input interface, the at least one chosen first-polarity voltage line is configured to be connected with the corresponding conductive member to further connect with the at least one corresponding output interface through a first compression force between the at least one chosen first-polarity voltage line and the corresponding output interface, and the at least one chosen second-polarity voltage line is configured to be connected with the corresponding conductive member to further connect with the at least one corresponding output interface through a second compression force between the at least one chosen second-polarity voltage line and the corresponding output interface.

In a further embodiment of the power supply system and the method for providing power to an electronic apparatus of the invention, each of the output interfaces includes an insulating member. The insulating member is configured to insulate the corresponding first-polarity voltage line from the corresponding second-polarity voltage line and to insulate the corresponding first-polarity voltage line and the corresponding second-polarity voltage line from the output interface.

In a further embodiment of the power supply device and the method for providing power of a power supply device of the invention, when the output interface is approached by the input interface, the chosen voltage line is configured to extend to connect with the output interface.

In a further embodiment of the power supply device and the method for providing power of a power supply device of the invention, both of the first-polarity voltage line and the second-polarity voltage line are extensible and magnetic. When the output interface is approached by the input interface, the chosen voltage line is configured to extend to connect with the output interface through a magnetic force between the chosen voltage line and the output interface.

In a further embodiment of the power supply device and the method for providing power of a power supply device of the invention, the output interface includes a conductive member. The conductive member is configured to be in connection between the output interface and the chosen voltage line. When the output interface is approached or forced by the input interface, the chosen voltage line is configured to be connected with the conductive member so as to further connect with the output interface.

In a further embodiment of the power supply device and the method for providing power of a power supply device of the invention, the conductive member is a magnetic switch. When the output interface is approached by the input interface, the chosen voltage line is configured to be connected with the conductive member to further connect with the output interface through a magnetic force between the chosen voltage line and the output interface.

In a further embodiment of the power supply device and the method for providing power of a power supply device of the invention above, the output interface is movable. When the output interface is forced by the input interface, the chosen voltage line with a first polarity is configured to be connected with the conductive member to further connect with the output interface through a first compression force between the chosen voltage line and the output interface, the chosen voltage line with a second polarity is configured to be connected with the conductive member to further connect with the output interface through a second compression force between the chosen voltage line and the output interface.

In a further embodiment of the power supply device and the method for providing power of a power supply device of the invention above, the output interface includes an insulating member. The insulating member is configured to insulate the first-polarity voltage line from the second-polarity voltage line and to insulate both of the first-polarity voltage line and the second-polarity voltage line from the output interface.

In a plurality of power supply devices of a power supply apparatus of a power supply system of the embodiments of the invention, at least one of the first-polarity voltage lines and at least one of the second-polarity voltage lines may be chosen as a voltage output for the power, and the at least one chosen first-polarity voltage line and the at least one chosen second-polarity voltage line belong to different power supply devices. In a power supply system of the embodiments of the invention, polarities within a polarity-to-be-determined area of a power supply apparatus may be determined by an input interface approaching or forcing the corresponding output interfaces of the corresponding power supply devices. Therefore the power supply device, the power supply apparatus, and the power supply system may have capability to automatically choose desired voltage line(s) with electrical polarity, and usage convenience may be improved and user habits may also be considered.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a drawing of side-view, schematically illustrating a power supply system and an electronic apparatus, according to an embodiment of the invention.

FIG. 2 is a drawing of top-view, schematically illustrating a power supply system, according to an embodiment of the invention.

FIG. 3 is a drawing of perspective-view, schematically illustrating a power supply system and electronic apparatus, according to another embodiment of the invention.

FIG. 4 is a drawing of perspective-view, schematically illustrating a power supply device, according to an embodiment of the invention.

FIG. 5 is a drawing of perspective-view, schematically illustrating a power supply device, according to an embodiment of the invention.

FIG. 6 is a drawing of perspective-view, schematically illustrating a power supply device, according to an embodiment of the invention.

FIG. 7 is a drawing of perspective-view, schematically illustrating an idle state of the power supply device in FIG. 4, according to an embodiment of the invention.

FIG. 8 is a drawing of perspective-view, schematically illustrating a first operation state of the power supply device in FIG. 4, according to an embodiment of the invention.

FIG. 9 is a drawing of perspective-view, schematically illustrating an idle state of the power supply device in FIG. 5, according to an embodiment of the invention.

FIG. 10 is a drawing of perspective-view, schematically illustrating a first operation state of the power supply device in FIG. 5, according to an embodiment of the invention.

FIGS. 11-12 are drawings of perspective-view, schematically illustrating a first operation state and a second operation state of the power supply device in FIG. 6, according to an embodiment of the invention.

FIG. 13 is a drawing, schematically illustrating a flow of a method for providing power to an electronic apparatus, according to an embodiment of the invention.

FIG. 14 is a drawing, schematically illustrating a flow of a method for providing power of a power supply device, according to an embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

The invention discloses a power supply device in multiple embodiments. The power supply devices may also be used to form a power supply system. Intended one of two voltage lines of the power supply device may be automatically and intelligently selected. As a result, when the user may freely plug the electronic apparatus, which is usually operate in direct current (DC) voltage, into the DC power source without worrying the occurrence of wrong connection for electrical polarity.

Several embodiments are provided for descriptions but not for limitation of the invention.

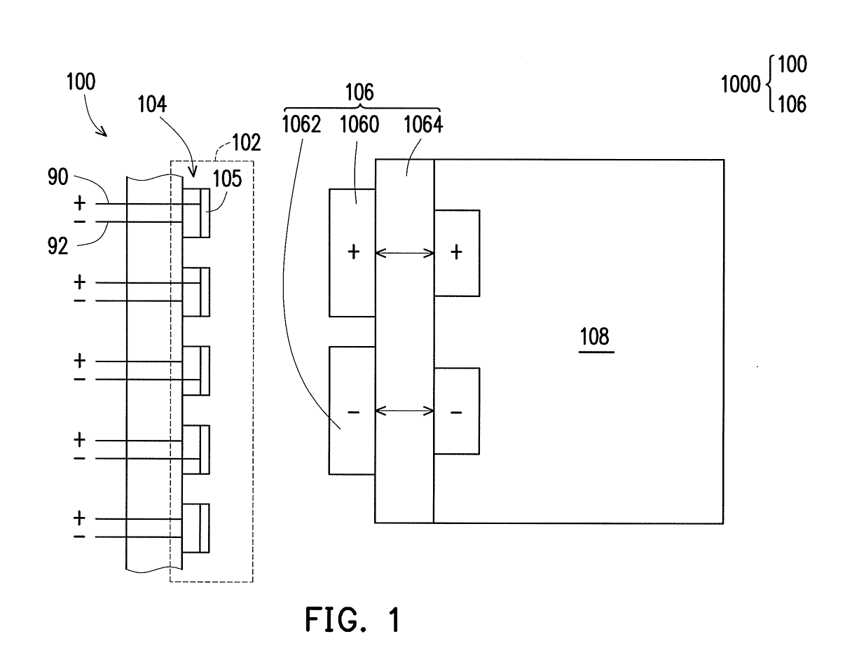

FIG. 1 is a drawing of side-view, schematically illustrating a power supply system and an electronic apparatus, according to an embodiment of the invention. Referring to FIG. 1, a power supply system 1000 may include a power supply apparatus 100 and an input interface 106. The input interface 106 is adapted to be coupled to an electronic apparatus 108, or generally coupled between the power supply apparatus 100 and the electronic apparatus 108. As an example, the input interface 106 may be implemented on the electronic apparatus 108. The input interface 106 may have a backplate 1064, a first pad 1060 and a second pad 1062. The backplate 1064 is for mechanical supporting. The first pad 1060 and the second pad 1062 are implemented on the backplate 1064, so as to respectively select to contact the first-polarity voltage line/lines (as mentioned below) and the second-polarity voltage line/lines (as mentioned below) of the power supply apparatus 100. In the embodiment, the backplate 1064 may also have interconnection route, so as to lead the voltage as chosen to the power terminals of the electronic apparatus 108. Therefore the electronic apparatus 108 may automatically obtain the power with the correct electrical polarity from the power supply apparatus 100. However, the input interface 106 formed with the first pad 1060, the second pad 1062, and the backplate 1064 is an example, but the invention is not limited thereto. In the other embodiment, the input interface 106 may be a device or dongle attached to/plugged in the electronic apparatus 108 or may be a device or circuit embedded in the electronic apparatus 108.

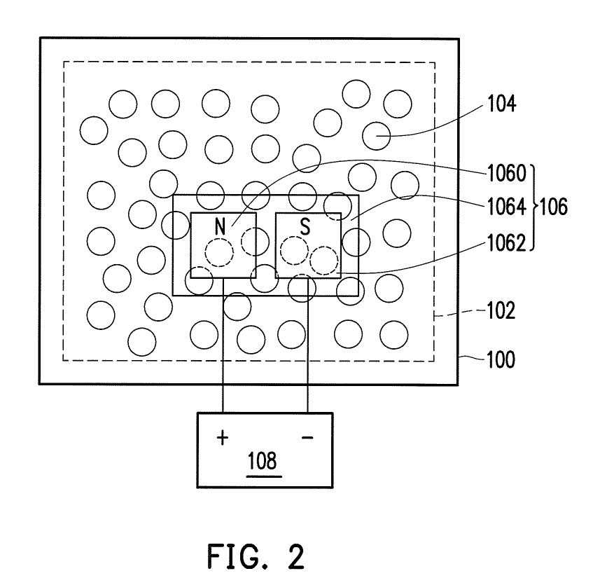

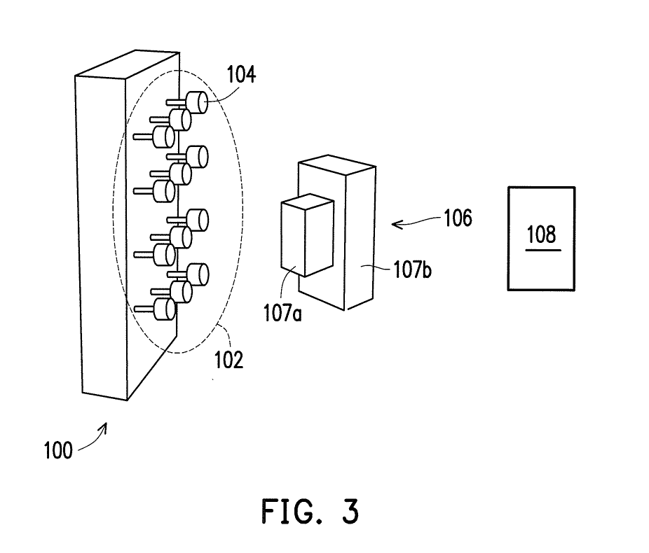

FIG. 2 is a drawing of top-view, schematically illustrating a power supply system, according to an embodiment of the invention. Referring to FIGS. 1-2, the power supply apparatus 100 may include a polarity-to-be-determined area 102 and a plurality of power supply devices 104 distributed in the polarity-to-be-determined area 102. The plurality of power supply devices 104 may distribute random or predetermined locations decided by the manufacturer. The electronic apparatus 108 is coupled to the power supply apparatus 100 through the input interface 106 and the plurality of power supply devices 104 to obtain a power, as shown in FIG. 2. In an embodiment, the plurality of power supply devices 104 may be fixed on a panel as an example, but the invention is not limited thereto. However, for any proper structure, the plurality of power supply devices 104 may also be a connection part of the power source apparatus as another example, in which power source apparatus may be a charger, a battery source, or any like. Nevertheless, in the other embodiment, the power supply apparatus 100 itself may be a socket (as mentioned in the following FIG. 3), a charger, a battery source, or any suitable device for supplying power. Therefore usage convenience may be improved and user habits may also be considered.

Further referring to FIG. 1, each of the plurality of power supply devices 104 comprises a first-polarity voltage line 90, a second-polarity voltage line 92, and an output interface 105. The plurality of first-polarity voltage lines 90 are disconnected with the plurality of second-polarity voltage lines 92. In one embodiment of the invention, the output interface 105 is approached or forced by the input interface 106 to accordingly choose at least one of the first-polarity voltage lines 90 and at least one of the second-polarity voltage lines 92 as a voltage output for the power. The at least one of the first-polarity voltage lines 90 is also referred as at least one chosen first-polarity voltage line and the at least one of the second-polarity voltage lines 92 is also referred as at least one chosen second-polarity voltage line. The at least one chosen first-polarity voltage line and the at least one chosen second-polarity voltage line belong to different power supply devices.

When the first pad 1060 approaches or forces (e.g. presses) the power supply devices 104, the first-polarity voltage lines 90 would connect to the output interface 105. Likewise, when the second pad 1062 approaches or presses the power supply devices 104, the second-polarity voltage lines 92 would connect to the output interface 105.

Referring to FIG. 2, taking the power panel as an example, the power supply devices 104 are distributed in the polarity-to-be-determined area 102. Each power supply device 104 may serve like a power node. The size of the first pad 1060 and the second pad 1062 may cover multiple power supply devices 104 in an example. The power supply devices 104 are approached or forced by the input interface 106. The power supply devices 104 corresponding to the first pad 1060 and the second pad 1062 are operated to choose corresponding one of the first-polarity voltage line 90 and the second-polarity voltage line 92 as the chosen first-polarity voltage lines or the chosen second-polarity voltage lines depending on the electrical polarity. To be more specific, as shown in FIGS. 1-2, the power supply devices 104 corresponding to the first pad 1060 are operated to choose the first-polarity voltage lines 90 (e.g. the two first-polarity voltage lines 90 of the upper two power supply devices 104 in FIG. 1) as the chosen first-polarity voltage lines depending on the positive polarity and the power supply devices 104 corresponding to the second pad 1062 are operated to choose the second-polarity voltage lines 92 (e.g. the two second-polarity voltage lines 92 of the third and fourth power supply devices 104 in FIG. 1) as the chosen second-polarity voltage lines depending on the negative polarity in an example.

FIG. 3 is a drawing of perspective-view, schematically illustrating a power supply system and an electronic apparatus, according to another embodiment of the invention. Referring to FIG. 3, in further another embodiment, the choosing method is based on the physical action, such as the force. The power supply devices 104 may be designed to have the elastic property as an example. The power supply devices 104 may be compressed into a first position or a second position by different compression forces from the interface 106. In order to apply the two different compression forces, the input interface 106 may be designed to have the step structure. The input interface 106 comprises one step from the compression piece 107a and another step from the compression piece 107b. In operation, as the input interface 106 compresses the power supply devices 104, the compression piece 107a may move the corresponding power supply devices 104 to a first position to connect to the first-polarity voltage lines 90 and the compression piece 107b may move the corresponding power supply devices 104 to a second position to connect to the second-polarity voltage lines 92. Besides, in FIG. 3, the power supply apparatus 100 is, for example, designed like a plug, such that the power supply devices 104 may be configured in the plug and the power supply apparatus 100 may be plugged in mains electricity through an AC/DC converter or adapter. Therefore usage convenience may be improved and user habits may also be considered. However the choosing method through forcing in detail would be described later.

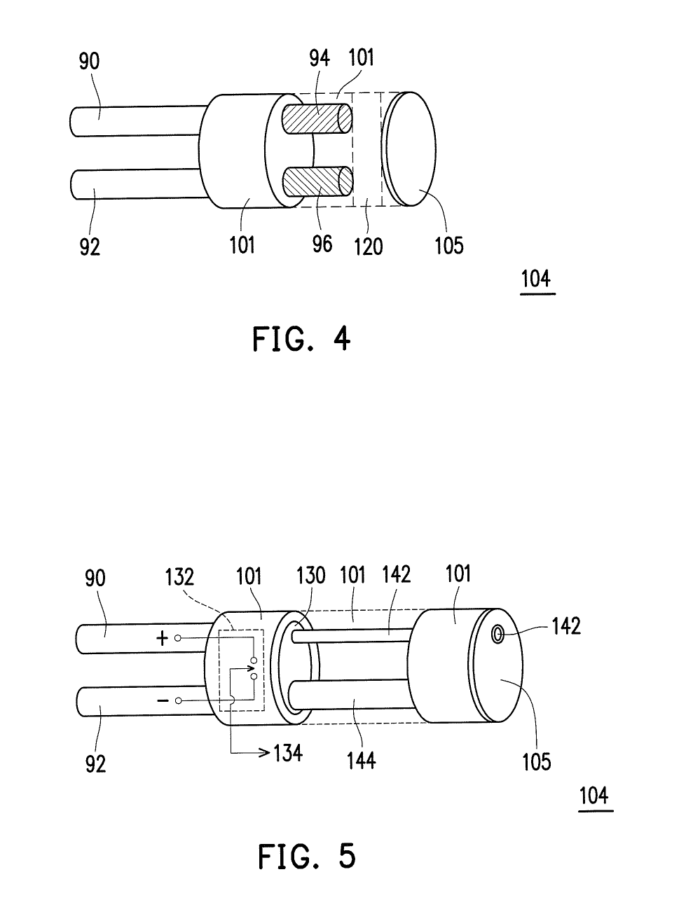

FIG. 4 is a drawing of perspective-view, schematically illustrating a power supply device, according to an embodiment of the invention. Referring to FIG. 4, the power supply device 104 in an embodiment includes a first-polarity voltage line 90, a second-polarity voltage line 92, and an output interface 105. The output interface 105 is distant from the ends of the first-polarity voltage line 90 and the second-polarity voltage line 92 by a gap 120 without connection.

In the embodiment shown in FIG. 4, the insulating structure 101 may be provided to insulate the first-polarity voltage line 90 carrying a first magnetic material 94 and the second-polarity voltage line 92 carrying a second magnetic material 96 from each other. The insulating structure 101 may actually support the output interface 105 and surround the ends of the first-polarity voltage line 90 and the second-polarity voltage line 92. The insulating structure 101 also may have the internal hollow space to allow the first-polarity voltage line 90 and the second-polarity voltage line 92 to move. However, the actually mechanical structure of the insulating structure 101 would depend on the actually need without limiting to specific one(s), and the invention is not limited thereto.

In the embodiment, the first-polarity voltage line 90 having an electrical polarity, such as the “+” polarity, is disconnected with the second-polarity voltage line 92 having an electrical polarity, such as the “−” polarity. The output interface 105 includes a conductive piece, such as a conductive disc in an example, but the invention is not limited thereto. The end part of the first-polarity voltage line 90 in the embodiment carries the first magnetic material 94, providing a first magnetic pole, such S pole at the end, in which the N pole is not in effect during operation. Likewise, the end part of the second-polarity voltage line 92 in the embodiment carries the second magnetic material 96, providing a second magnetic pole, such N pole at the end, in which the S pole is not in effect during operation.

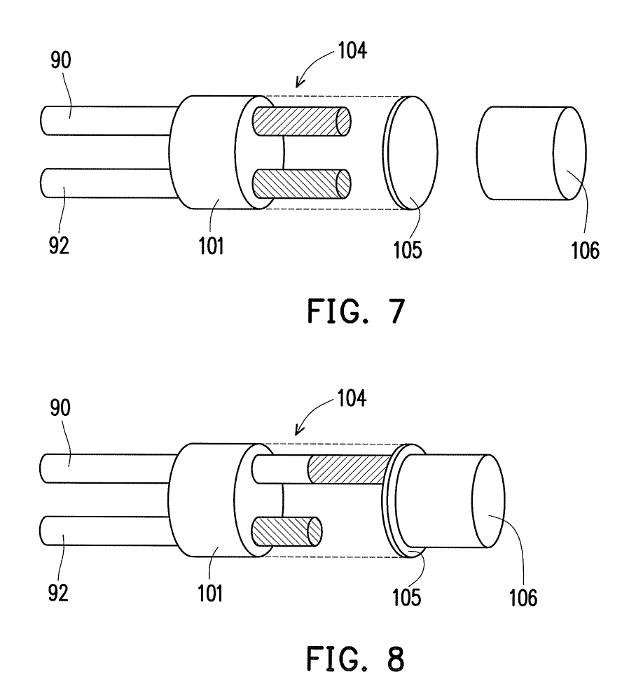

For the choosing method, please referring to FIGS. 1-2 and FIG. 4, in the embodiment, the first pad 1060 of the input interface 106 may be a magnetic material having N pole at the end and the second pad 1062 of the input interface 106 may be a magnetic material having S pole at the end. The magnetic poles of the first pad 1060 and the second pad 1062 are different from the magnetic poles of the end of the first-polarity voltage line 90 and the second-polarity voltage line 92, respectively, to cause the attraction effect or repelling effect. When the power supply device 104 with the magnetic end is approached by pad 1060 or/and 1062 of the input interface 106, the magnetic fore in attraction is induced, so that the attracted one is connected to the output interface 105 to have the power with the chosen polarity and the repelled one is further moved far from the output interface 105. However, the detailed choosing method would be further described in FIGS. 7-8 later.

FIG. 5 is a drawing of perspective-view, schematically illustrating a power supply device, according to an embodiment of the invention. Please referring to FIG. 5, the power supply device 104 may also be based on magnetic force but in different design to achieve the choosing capability. In order to choose one of the first-polarity voltage line 90 and the second-polarity voltage line 92 to the output interface 105 with the intended electrical polarity, a magnetic switch 130 may be used. The equivalent circuit of the magnetic switch 130 is, for example, shown by a magnetic switching circuit 132. Based on the magnetic switching control, the output terminal 134 is the chosen one of the first-polarity voltage line 90 and the second-polarity voltage line 92. In structure, the magnetic switch 130 may further include the control member 142 and the connecting member 144 as an example. In the embodiment, the control member 142 is insulated from the output interface 105. The output interface 105 is disposed on the end of the insulate structure 101. The control member 142 and the connecting member 144 may form as a conductive member for performing the control mechanism.

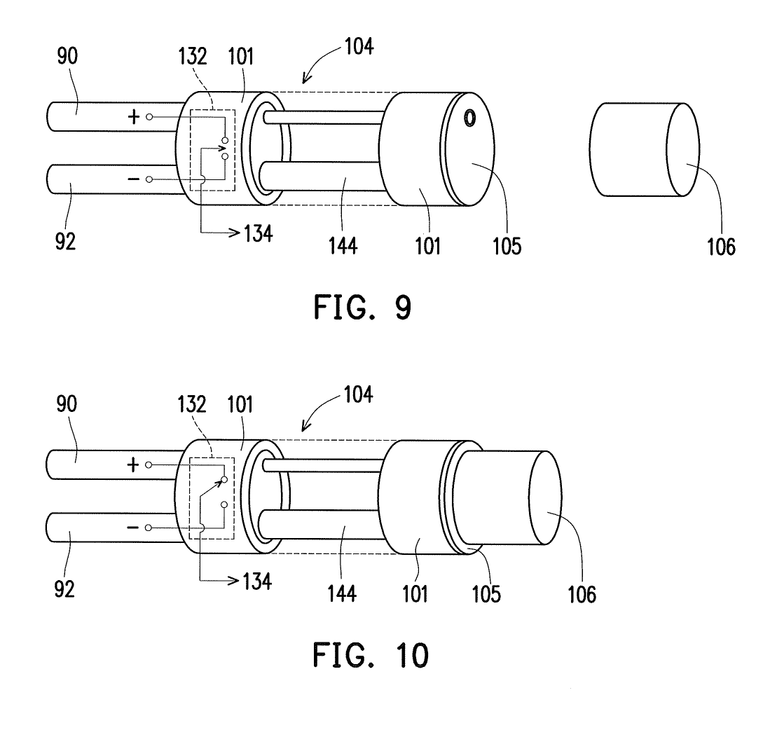

When the input interface 106 in FIGS. 1-2 and FIG. 5 as previously described approaches to the power supply device 104, the magnetic force with the intended magnetic pole induces the magnetic switching circuit 132 of the magnetic switch 130 through the control member 142, so the chosen one of the first-polarity voltage line 90 and the second-polarity voltage line 92 is connected to the connecting member 144 and is also connected to the output interface 105. As a result, the output interface 105 serving as the output terminal 134 has the voltage with the intended electrical polarity, such as “+” polarity or “−“ polarity”. However, the detailed choosing method would be further described in FIGS. 9-10 later.

Likewise, the insulating structure 101 is used for general insulating function while the power supply device 104 may work properly and is not limited to specific structure(s).

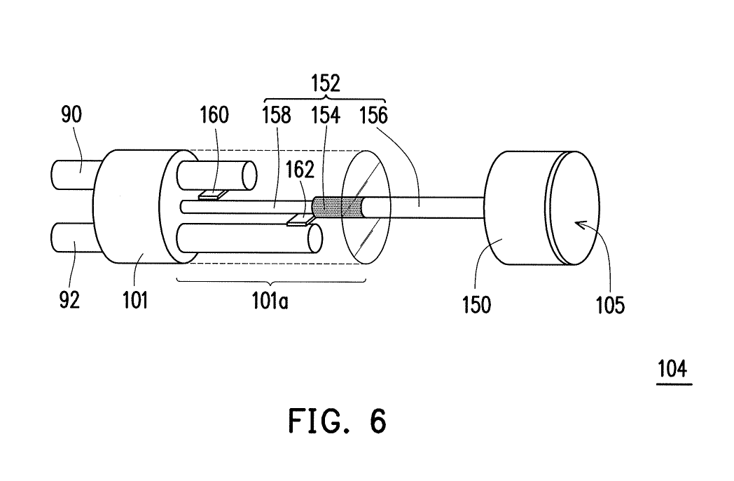

In the foregoing embodiments of FIGS. 4-5, the power supply device 104 is operated based on magnetic force. However, under the same aspect of the invention, the power supply device 104 may be designed to be based on the mechanical effect as shown in FIG. 6. FIG. 6 is a drawing of perspective-view, schematically illustrating a power supply device, according to an embodiment of the invention. Referring to FIG. 6, the insulating structure 101 of the power supply device 104 may have the hollow part 101a, and the hollow part 101a may provide a space for adapting an internal structure of the power supply device 104 around the ends parts of the first-polarity voltage line 90 and the second-polarity voltage line 92. The power supply device 104 in the embodiment may further include a movable member 150 and a coupling structure 152, and the coupling structure 152 may include a conductive rod 154, an insulating coating layer 156, and a supporting rod 158.

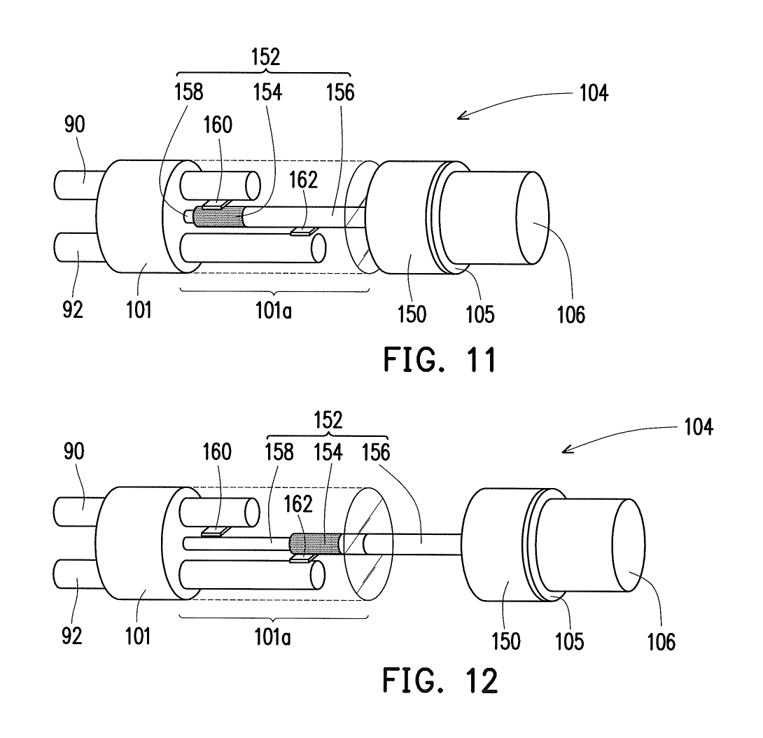

Please referring to FIGS. 1-2 and FIG. 6, the end parts of the first-polarity voltage line 90 and the second-polarity voltage line 92 may be respectively implemented with the connection piece 160 and the connection piece 162, and the connection piece 160 and the connection piece 162 are located at different positions relative to the output interface 105 for corresponding to the first-polarity voltage line 90 and the second-polarity voltage line 92 respectively. In the embodiment, the output interface 105 is disposed on the end of the movable member 150, and the supporting rod 158 within the hollow part 101a of the insulating structure 101 is mechanically fixed to serve as the supporting reference. In the embodiment, the conductive rod 154 is partly coated with, for example, the insulating coating layer 156 for insulation effect. The conductive rod 154 in the embodiment may be hollow and put on the supporting rod 158 with sliding capability, and the conductive rod 154 may also be moving on supporting rod 158 in according with the movement of the movable member 150. However, an elastic member, such as a spring (not shown), may be put between the supporting rod 158 and the conductive rod 154 to respond the externally applied force on the movable member 150. Depending on the force, such as compression force, applied to the movable member 150 from the input interface 106, the exposed portion of the conductive rod 154 may contact the connection piece 160 or the connection piece 162, so as to obtain the voltage power with designated electrical polarity thereon. Therefore the voltage power is then transmitted to the output interface 105 through the conductive rod 154. Besides, in the embodiment, due to the elastic member (e.g. spring), when no force is applied, the conductive rod 154 would not contact the connection piece 160 and the connection piece 162. For the control mechanism above, the conductive rod 154, the connection piece 160, and the connection piece 162 may form as a conductive member for performing the control mechanism. However, the detailed choosing method would be further described in FIGS. 11-12 later.

FIG. 7 is a drawing of perspective-view, schematically illustrating an idle state of the power supply device in FIG. 4, according to an embodiment of the invention. Referring to FIGS. 4, 7, the polarity-to-be-determined area 102 (shown in FIG. 2) is in an idle state, and the power supply device 104 is not used yet for providing the voltage power in the idle state. As a result, none of the first-polarity voltage line 90 and the second-polarity voltage line 92 is connected to the output interface 105, and no power is generated/provided/output.

FIG. 8 is a drawing of perspective-view, schematically illustrating a first operation state of the power supply device in FIG. 4, according to an embodiment of the invention. Referring to FIG. 8, when the input interface 106 with the magnetic force approaches to or even with real contact to the power supply device 104, the input interface 106 with the effecting magnetic pole would attract one of the first-polarity voltage line 90 and the second-polarity voltage line 92 and repels another one of the first-polarity voltage line 90 and the second-polarity voltage line 92. The attracted one as the chosen first-polarity voltage line 90 or the chosen second-polarity voltage line 92 is connected to the output interface 105 for providing the voltage power. In the first operation state of the embodiment, the attracted one (the chosen polarity voltage line) is, for example, the first-polarity voltage line 90 is connected to the output interface 105 for providing the voltage power. However the attracted one (the chosen polarity voltage line) connected to the output interface 105 may be the second-polarity voltage line 92 for providing the voltage power in a second operation state in the other unshown embodiment.

FIG. 9 is a drawing of perspective-view, schematically illustrating an idle state of the power supply device in FIG. 5, according to an embodiment of the invention. Referring to FIGS. 5, 9, the polarity-to-be-determined area 102 (shown in FIG. 2) is in an idle state, and the power supply device 104 is not used yet for providing the voltage power in the idle state. As a result, the magnetic switch circuit 132 in FIGS. 5, 9 is a open circuit without connecting to the N-pole terminal or the S-pole terminal, and no voltage power is generated/provided/output.

FIG. 10 is a drawing of perspective-view, schematically illustrating a first operation state of the power supply device in FIG. 5, according to an embodiment of the invention. Referring to FIG. 10, when the input interface 106 with the magnetic force approaches to or even with real contact to the power supply device 104, the magnetic switch circuit 132 is controlled to connect to the N-pole terminal or the S-pole terminal. In the embodiment, the closed circuit is formed through the first-polarity voltage line 90 (the chosen polarity voltage line) as an example within the magnetic switch circuit 132 and the connecting member 144 serving as the output terminal 134 transports the chosen voltage, such as the “+” voltage to the output interface 105 via the connecting member 144 for providing the voltage power. However the closed circuit may formed through the second-polarity voltage line 92 (the chosen polarity voltage line) within the magnetic switch circuit 132 and the connecting member 144 serving as the output terminal 134 transports the chosen voltage, such as the “−” voltage to the output interface 105 via the connecting member 144 for providing the voltage power in the other not-shown embodiment.

FIGS. 11-12 are drawings of perspective-view, schematically illustrating a first operation state and a second operation state of the power supply device in FIG. 6, according to an embodiment of the invention. In the embodiment, the polarity-to-be-determined area 102 (shown in FIG. 3) is in an idle state and the power supply device 104 is not used yet for providing the voltage power in the idle state in FIG. 6, the power supply device 104 is controlled by a first compressing force so as to move the movable member 150 to a position which allows the conductive rod 154 to contact with the connection piece 160 in a first operation state of FIG. 11, and the power supply device 104 is controlled by a second compressing force so as to move the movable member 150 to a position which allows the conductive rod 154 to contact with the connection piece 162 in a second operation state of FIG. 12.

In the embodiment of FIG. 11, the voltage on the first-polarity voltage line 90 is transported to the output interface 105. Here in the embodiment as an example, the insulating coating layer 156 avoid the contact between the conductive rod 154 and the connection piece 162 on the second-polarity voltage line 92. Otherwise, in the embodiment of FIG. 12, the voltage on the second-polarity voltage line 92 is transported to the output interface 105.

As described above, a single power supply device may be controlled to only choose one voltage line with the intended polarity (i.e. only first voltage line 90 with the first polarity or only second voltage line 92 with the second polarity). However, the working power for the electronic apparatus 108 would need two different power terminals with different electrical polarities, that is, at least one of first voltage lines 90 and at least one of second voltage lines 92 belong to different power supply devices 104 would be chosen. So, in order to provide sufficient power to the electronic apparatus 108, a plurality of the power supply devices 104 may be arranged as a power panel as an example shown in FIG. 2 or configured in a plug as an example shown in FIG. 3 or designed in an any other suitable device/carrier/structure/shape. Further, the input interface 106 may be connected between the electronic apparatus 108 and power supply apparatus 100, the first pad 1060 in FIG. 2 or compressing piece 107a in FIG. 3 may contact at least one of the power supply devices 104 and choose at least one of the first-polarity voltage lines 90 with the same electrical polarity (e.g. first polarity with positive electricity) for output the voltage; similarly, the second pad 1062 in FIG. 2 or compressing piece 107b in FIG. 3 may contact at least one of the power supply device 104 and choose at least one of the second-polarity voltage lines 92 with another same electrical polarity (e.g. second polarity with negative electricity) for output the another voltage.

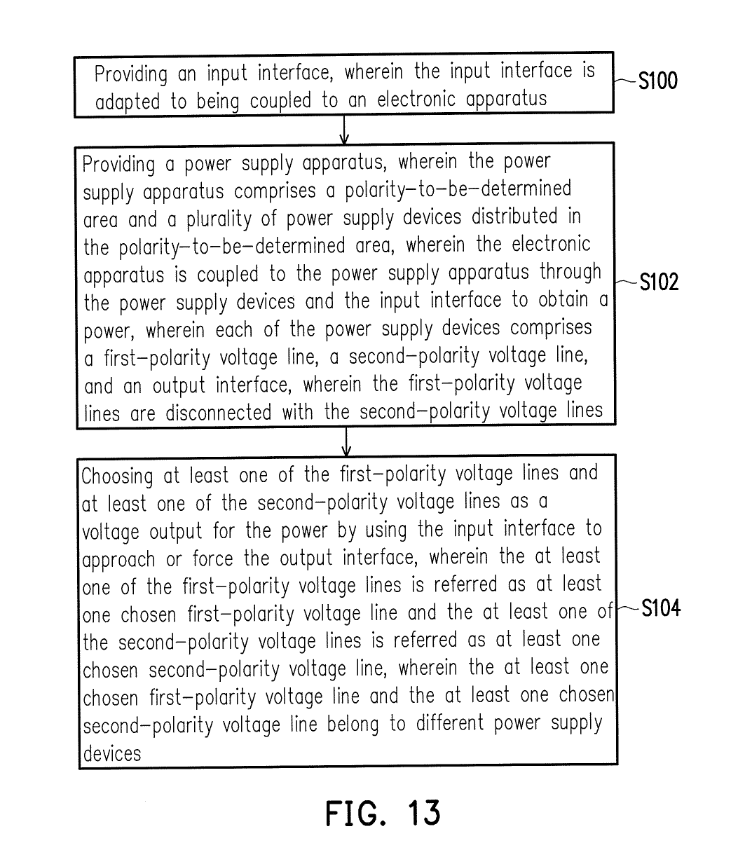

Further, as an aspect of the invention, in an embodiment, a method for providing power to an electronic apparatus is disclosed. FIG. 13 is a drawing, schematically illustrating a flow of a method for providing power to an electronic apparatus, according to an embodiment of the invention.

Referring to FIG. 13, step S100 is providing an input interface, wherein the input interface is adapted to being coupled to an electronic apparatus. Step S102 is providing a power supply apparatus, wherein the power supply apparatus comprises a polarity-to-be-determined area and a plurality of power supply devices distributed in the polarity-to-be-determined area, wherein the electronic apparatus is coupled to the power supply apparatus through the power supply devices and the input interface to obtain a power, wherein each of the power supply devices comprises a first-polarity voltage line, a second-polarity voltage line, and an output interface, wherein the first-polarity voltage lines are disconnected with the second-polarity voltage lines. Step S104 is choosing at least one of the first-polarity voltage lines and at least one of the second-polarity voltage lines as a voltage output for the power by using the input interface to approach or force the output interface, wherein the at least one of the first-polarity voltage lines is referred as at least one chosen first-polarity voltage line and the at least one of the second-polarity voltage lines is referred as at least one chosen second-polarity voltage line, wherein the at least one chosen first-polarity voltage line and the at least one chosen second-polarity voltage line belong to different power supply devices.

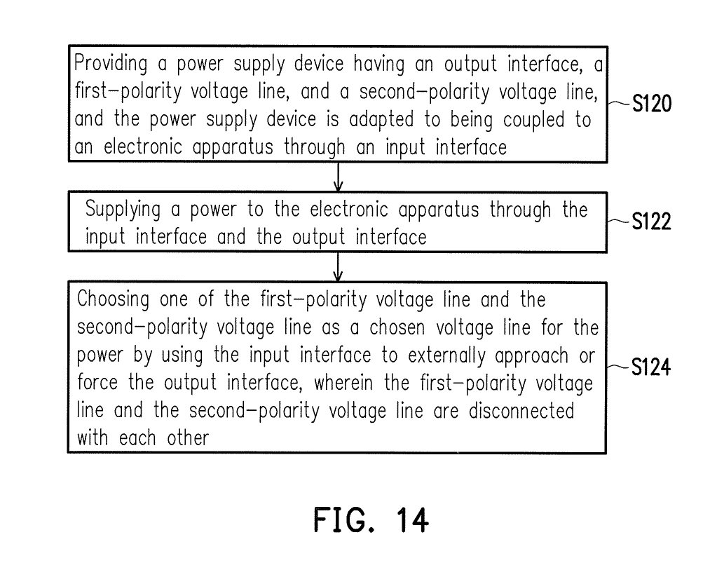

As another aspect of the invention, in an embodiment, a method for providing power of a power supply device is disclosed. FIG. 14 is a drawing, schematically illustrating a flow of a method for providing power of a power supply device, according to an embodiment of the invention.

Referring to FIG. 14, step S120 is providing a power supply device having an output interface, a first-polarity voltage line, and a second-polarity voltage line, and the power supply device is adapted to being coupled to an electronic apparatus through an input interface. Step S122 is supplying a power to the electronic apparatus through the input interface and the output interface. Step S124 is choosing one of the first-polarity voltage line and the second-polarity voltage line as a chosen voltage line for the power by using the input interface to externally approach or force the output interface, wherein the first-polarity voltage line and the second-polarity voltage line are disconnected with each other.

Accordingly, in a plurality of power supply devices of a power supply apparatus of a power supply system of the embodiments of the invention, at least one of the first-polarity voltage lines and at least one of the second-polarity voltage lines may be chosen as a voltage output for the power, and the at least one chosen first-polarity voltage line and the at least one chosen second-polarity voltage line belong to different power supply devices. In a power supply system of the embodiments of the invention, polarities within a polarity-to-be-determined area of a power supply apparatus may be determined by an input interface approaching or forcing the corresponding output interfaces of the corresponding power supply devices. In the embodiments of the invention, the power supply device may be a DC power supply device, the power supply apparatus may be a DC power supply apparatus, and the power supply system may be a DC power supply system. Therefore the power supply device, the power supply apparatus, and the power supply system may have capability to automatically choose desired voltage line(s) with electrical polarity, and usage convenience may be improved and user habits may also be considered.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims. Moreover, these claims may refer to use “first”, “second”, etc. following with noun or element. Such terms should be understood as a nomenclature and should not be construed as giving the limitation on the number of the elements modified by such nomenclature unless specific number has been given.

What is claimed is:

1. A power supply system, comprising:
an input interface, adapted to being coupled to an electronic apparatus; and
a power supply apparatus, comprising a polarity-to-be-determined area and a plurality of power supply devices distributed in the polarity-to-be-determined area, wherein the electronic apparatus is coupled to the power supply apparatus through the input interface and the power supply devices to obtain a power,
wherein each of the plurality of the power supply devices comprises a first-polarity voltage line, a second-polarity voltage line, and an output interface, wherein the first-polarity voltage lines of the plurality of the power supply devices are disconnected with the second-polarity voltage lines of the plurality of the power supply devices, wherein the output interface is approached or forced by the input interface to accordingly choose at least one of the first-polarity voltage lines and at least one of the second-polarity voltage lines as a voltage output for the power, wherein the at least one of the first-polarity voltage lines is referred as at least one chosen first-polarity voltage line and the at least one of the second-polarity voltage lines is referred as at least one chosen second-polarity voltage line, wherein the at least one chosen first-polarity voltage line and the at least one chosen second-polarity voltage line belong to the different power supply devices.

2. The power supply system according to claim 1, wherein when the output interfaces of the plurality of the power supply devices are approached by the input interface, the at least one chosen first-polarity voltage line and the at least one chosen second-polarity voltage line are configured to extend to respectively connect with the corresponding output interfaces, and the other first-polarity voltage lines and the other second-polarity voltage lines are in disconnection with the output interfaces.

3. The power supply system according to claim 1, wherein each of the first-polarity voltage lines and the second-polarity voltage lines is extensible and magnetic, when the output interfaces are approached by the input interface, the at least one chosen first-polarity voltage line is configured to extend to connect with the at least one corresponding output interface through a first magnetic force between the at least one chosen first-polarity voltage line and the corresponding output interface, and the at least one chosen second-polarity voltage line is configured to extend to connect with the at least one corresponding output interface through a second magnetic force between the at least one chosen second-polarity voltage line and the corresponding output interface.

4. The power supply system according to claim 1, wherein each of the output interfaces comprises:
a conductive member, configured to be in connection between the corresponding output interface and the corresponding chosen first-polarity voltage line or between the corresponding output interface and the corresponding chosen second-polarity voltage line,
wherein when the output interfaces are approached or forced by the input interface, the at least one chosen first-polarity voltage line is configured to be connected with the corresponding conductive member so as to further connect with the corresponding output interface, the at least one chosen second-polarity voltage line is configured to be connected with the corresponding conductive member so as to further connect with the corresponding output interface, and the other first-polarity voltage lines and the other second-polarity voltage lines are in disconnection with the output interfaces.

5. The power supply system according to claim 4, wherein the conductive members are magnetic switches, when the output interfaces are approached by the input interface, the at least one chosen first-polarity voltage line is configured to be connected with the corresponding conductive member to further connect with the at least one corresponding output interface through a first magnetic force between the at least one chosen first-polarity voltage line and the corresponding output interface, and the at least one chosen second-polarity voltage line is configured to be connected with the corresponding conductive member to further connect with the at least one corresponding output interface through a second magnetic force between the at least one chosen second-polarity voltage line and the corresponding output interface.

6. The power supply system according to claim 4, wherein the output interfaces are movable, when the output interfaces are forced by the input interface, the at least one chosen first-polarity voltage line is configured to be connected with the corresponding conductive member to further connect with the at least one corresponding output interface through a first compression force between the at least one chosen first-polarity voltage line and the corresponding output interface, and the at least one chosen second-polarity voltage line is configured to be connected with the corresponding conductive member to further connect with the at least one corresponding output interface through a second compression force between the at least one chosen second-polarity voltage line and the corresponding output interface.

7. The power supply system according to claim 1, wherein each of the output interfaces comprises:
an insulating member, configured to insulate the corresponding first-polarity voltage line from the corresponding second-polarity voltage line and to insulate the corresponding first-polarity voltage line and the corresponding second-polarity voltage line from the output interface.

8. A power supply device, adapted to being coupled to an electronic apparatus through an input interface, the power supply device comprising:
a first-polarity voltage line and a second-polarity voltage line, disconnected with each other; and
an output interface, configured to supply a power to the electronic apparatus through the input interface, wherein when the output interface is externally approached or forced by the input interface, the output interface chooses one of the first-polarity voltage line and the second-polarity voltage line as a chosen voltage line for the power.

9. The power supply device according to claim 8, wherein when the output interface is approached by the input interface, the chosen voltage line is configured to extend to connect with the output interface.

10. The power supply device according to claim 8, wherein both of the first-polarity voltage line and the second-polarity voltage line are extensible and magnetic, when the output interface is approached by the input interface, the chosen voltage line is configured to extend to connect with the output interface through a magnetic force between the chosen voltage line and the output interface.

11. The power supply device according to claim 8, wherein the output interface comprises:
a conductive member, configured to be in connection between the output interface and the chosen voltage line,
wherein when the output interface is approached or forced by the input interface, the chosen voltage line is configured to be connected with the conductive member so as to further connect with the output interface.

12. The power supply device according to claim 11, wherein the conductive member is a magnetic switch, when the output interface is approached by the input interface, the chosen voltage line is configured to be connected with the conductive member to further connect with the output interface through a magnetic force between the chosen voltage line and the output interface.

13. The power supply device according to claim 11, wherein the output interface is movable, when the output interface is forced by the input interface, the chosen voltage line with a first polarity is configured to be connected with the conductive member to further connect with the output interface through a first compression force between the chosen voltage line and the output interface, the chosen voltage line with a second polarity is configured to be connected with the conductive member to further connect with the output interface through a second compression force between the chosen voltage line and the output interface.

14. The power supply device according to claim 8, wherein the output interface comprises:
an insulating member, configured to insulate the first-polarity voltage line from the second-polarity voltage line and to insulate both of the first-polarity voltage line and the second-polarity voltage line from the output interface.

15. A method for providing power to an electronic apparatus, the method comprising:
providing an input interface, wherein the input interface is adapted to being coupled to the electronic apparatus;
providing a power supply apparatus, wherein the power supply apparatus comprises a polarity-to-be-determined area and a plurality of power supply devices distributed in the polarity-to-be-determined area, wherein the electronic apparatus is coupled to the power supply apparatus through the power supply devices and the input interface to obtain a power, wherein each of the power supply devices comprises a first-polarity voltage line, a second-polarity voltage line, and an output interface, wherein the first-polarity voltage lines are disconnected with the second-polarity voltage lines; and
choosing at least one of the first-polarity voltage lines and at least one of the second-polarity voltage lines as a voltage output for the power by using the input interface to approach or force the output interface, wherein the at least one of the first-polarity voltage lines is referred as at least one chosen first-polarity voltage line and the at least one of the second-polarity voltage lines is referred as at least one chosen second-polarity voltage line, wherein the at least one chosen first-polarity voltage line and the at least one chosen second-polarity voltage line belong to different power supply devices.

16. The method for providing power according to claim 15, wherein when the output interfaces are approached by the input interface, the at least one chosen first-polarity voltage line and the at least one chosen second-polarity voltage line are configured to extend to respectively connect with the corresponding output interfaces, and the other first-polarity voltage lines and the other second-polarity voltage lines are in disconnection with the output interfaces.

17. The method for providing power according to claim 15, wherein each of the first-polarity voltage lines and the second-polarity voltage lines is extensible and magnetic, when the output interfaces are approached by the input interface, the at least one chosen first-polarity voltage line is configured to extend to connect with the at least one corresponding output interface through a first magnetic force between the at least one chosen first-polarity voltage line and the corresponding output interface, and the at least one chosen second-polarity voltage line is configured to extend to connect with the at least one corresponding output interface through a second magnetic force between the at least one chosen second-polarity voltage line and the corresponding output interface.

18. The method for providing power according to claim 15, further providing each of the output interfaces with a conductive member, wherein the conductive member of the corresponding output interface is configured to be in connection between the corresponding output interface and the corresponding chosen first-polarity voltage line or between the corresponding output interface and the corresponding chosen second-polarity voltage line,
wherein when the output interfaces are approached or forced by the input interface, the at least one chosen first-polarity voltage line is configured to be connected with the corresponding conductive member so as to further connect with the corresponding output interface, the at least one chosen second-polarity voltage line is configured to be connected with the corresponding conductive member so as to further connect with the corresponding output interface, and the other first-polarity voltage lines and the other second-polarity voltage lines are in disconnection with the output interfaces.

19. The method for providing power according to claim 18, wherein the conductive members are magnetic switches, when the output interfaces are approached by the input interface, the at least one chosen first-polarity voltage line is configured to be connected with the corresponding conductive member to further connect with the at least one corresponding output interface through a first magnetic force between the at least one chosen first-polarity voltage line and the corresponding output interface, and the at least one chosen second-polarity voltage line is configured to be connected with the corresponding conductive member to further connect with the at least one corresponding output interface through a second magnetic force between the at least one chosen second-polarity voltage line and the corresponding output interface.

20. The method for providing power according to claim 18, wherein the output interfaces are movable, when the output interfaces are forced by the input interface, the at least one chosen first-polarity voltage line is configured to be connected with the corresponding conductive member to further connect with the at least one corresponding output interface through a first compression force between the at least one chosen first-polarity voltage line and the corresponding output interface, and the at least one chosen second-polarity voltage line is configured to be connected with the corresponding conductive member to further connect with the at least one corresponding output interface through a second compression force between the at least one chosen second-polarity voltage line and the corresponding output interface.

21. The method for providing power according to claim 15, further providing each of the output interfaces with an insulating member, the insulating member of the corresponding output interface is configured to insulate the corresponding first-polarity voltage line from the corresponding second-polarity voltage line and to insulate the corresponding first-polarity voltage line and the corresponding second-polarity voltage line from the output interface.

22. A method for providing power of a power supply device, the power supply device is adapted to being coupled to an electronic apparatus through an input interface, the method comprising:
providing the power supply device having an output interface, a first-polarity voltage line, and a second-polarity voltage line;
supplying a power to the electronic apparatus through the input interface and the output interface; and
choosing one of the first-polarity voltage line and the second-polarity voltage line as a chosen voltage line for the power by using the input interface to externally approach or force the output interface, wherein the first-polarity voltage line and the second-polarity voltage line are disconnected with each other.

23. The method for providing power according to claim 22, wherein when the output interface is approached by the input interface, the chosen voltage line is configured to extend to connect with the output interface.

24. The method for providing power according to claim 22, wherein both of the first-polarity voltage line and the second-polarity voltage line are extensible and magnetic, when the output interface is approached by the input interface, the chosen voltage line is configured to extend to connect with the output interface through a magnetic force between the chosen voltage line and the output interface.

25. The method for providing power according to claim 22, further providing the output interface with a conductive member, wherein the conductive member is configured to be in connection between the output interface and the chosen voltage line,
wherein when the output interface is approached or forced by the input interface, the chosen voltage line is configured to be connected with the conductive member so as to further connect with the output interface.

26. The method for providing power according to claim 25, wherein the conductive member is a magnetic switch, when the output interface is approached by the input interface, the chosen voltage line is configured to be connected with the conductive member to further connect with the output interface through a magnetic force between the chosen voltage line and the output interface.

27. The method for providing power according to claim 25, wherein the output interface is movable, when the output interface is forced by the input interface, the chosen voltage line with a first polarity is configured to be connected with the conductive member to further connect with the output interface through a first compression force between the chosen voltage line and the output interface, the chosen voltage line with a second polarity is configured to be connected with the conductive member to further connect with the output interface through a second compression force between the chosen voltage line and the output interface.

28. The method for providing power according to claim 22, further providing the output interface with an insulating member, wherein the insulating member is configured to insulate the first-polarity voltage line from the second-polarity voltage line and to insulate both of the first-polarity voltage line and the second-polarity voltage line from the output interface.
